(19) United States
(12) Patent Application Publication
(10) Pub. No.: US 2010/0153587 A1
(43) Pub. Date: Jun. 17, 2010

(54) METHOD OF SETTING MODE OF EXTERNAL DEVICE OPERABLE IN PLURALITY OF MODES AND COMMUNICATION DEVICE TO USE THE SAME

(75) Inventor: Juang-hwan CHOI, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/633,140

(22) Filed: Dec. 8, 2009

(30) Foreign Application Priority Data
Dec. 17, 2008 (KR) 2008-128588

(51) Int. Cl. G06F 3/00

(52) U.S. Cl. 710/14

(57) ABSTRACT

A method of setting a mode of an external device which is operable in a plurality of modes and a communication device using the same. The method of setting a mode controls the external device to be operated in at least one mode of a plurality of modes according to the movement of a terminal of the communication device to which the external device is connected. Accordingly, it is possible to operate the external device in the mode which is desired by a user through the movement of the terminal to which the external device or the plug of the cable is connected.

### CROSS-REFERENCE TO RELATED APPLICATIONS

This application claims priority under 35 U.S.C. §119 (a) from Korean Patent Application No. 10-2008-128588, filed on Dec. 17, 2008, in the Korean Intellectual Property Office, the disclosure of which is incorporated herein by reference in its entirety.

### BACKGROUND

1. Field of the Invention

The present general inventive concept relates to a method of operating an external device in a mode selected by a user, and more particularly, to a device which has a function of connecting an external device through a wire such as universal serial bus (USB) and IEEE 1394.

2. Description of the Related Art

The USB refers to a general interface standard which is widely used in a PC, an MP3 player, a mobile phone, or a laptop computer, and has been updated to versions 1, 1.1, 2.0, and 3.0. The completed version has been commercialized and widely used in various data communication devices. In addition, IEEE 1394 is an already-prescribed standard and is widely used in various products.

FIG. 1 is a view illustrating a state before a conventional external device (not illustrated) is connected to a terminal 10 of a communication device through a cable 20.

If the plug of the cable 20 connected to the external device is inserted into the terminal 10 of the communication device, the external device can communicate with the communication device or can be supplied with power from the communication device.

However, such a conventional method to connect the external device to the communication device causes problems in use. For example, the external device may be operated in a mode which is not desired by the user or the communication device may perform an unnecessary operation to prepare the connection. Therefore, the performance of the communication device deteriorates or the unnecessary operation causes the delay in completing an operation.

More specifically, even if the user wishes to connect the external device only for the purpose of supplying power to the external device, a program for data communication is loaded and operation for preparing data communication is performed. These operations cause confusion to the user and deteriorate performance of the communication device.

That is, since the communication device connected to the external device in the conventional method performs a preparing operation in a predefined order without understanding the user's intention, the above problems are caused.

### SUMMARY

The present general inventive concept provides a method of determining a mode of an external device according to user's intention and operating the external device only in the mode which is desired by the user, thereby enabling data communication and power supply more effectively without an unnecessary preparing process and an unnecessary operation, and a device to use the method thereof.

Additional features and utilities of the present general inventive concept will be set forth in part in the description which follows and, in part, will be obvious from the description, or may be learned by practice of the general inventive concept.

Exemplary embodiments of the present general inventive concept may be achieved by providing a method of setting a mode of an external device which is operable in a plurality of modes, the method including connecting the external device to a communication device, moving a terminal to which the external device is connected by a user, and controlling the external device to be operated in at least one mode of the plurality of modes according to the movement of the terminal by the user.

The communication device in the connecting operation may be a device which performs a communication function and a power supply function. The communication device in the connecting operation may communicate at a plurality of speeds. The communication device in the connecting operation may communicate according to a USB interface standard or an IEEE 1394 interface standard.

The movement of the terminal by the user in the moving operation may include at least one of rotational, vertical, horizontal, and forward and backward movements.

The plurality of modes may include a charging mode. The plurality of modes may include a mode according to a plurality of transmission speeds according the same interface standard. The plurality of modes may include a mode according to different versions of the same interface standard. The plurality of modes may include at least two of a charging mode, an interactive communication mode, a one-way communication mode, a master mode, and a slave mode.

Exemplary embodiments of the present general inventive concept may be also achieved by providing a communication device which is connectible with an external device which is operable in a plurality of modes, the communication device including a connector which is movably installed and is connected to the external device, and a controller which determines a mode of the external device based on movement of the connector. The plurality of modes may include at least two modes of a communication mode, a charging mode, an interactive communication mode, a one-way communication mode, a master mode, a slave mode, a mode according to a plurality of transmission speeds according to the same interface standard, and a mode according to different versions of the same interface standard. The movement of the connector may include at least one of rotational, vertical, horizontal and forward and backward movements.

Exemplary embodiments of the present general inventive concept may be also achieved by providing a communication device including a connector which is movable by a user's manipulation and is connected to an external device which is operable in a plurality of modes, and a controller which determines a mode of the external device based on a movement of the connector and controls the external device to be operated in the determined mode.

The user's manipulation may be a manipulation to move the external device along with the connector or a manipulation to move a plug of a cable connected to the external device along with the connector.

The movement of the connector by the user's manipulation may include one of rotational, horizontal, vertical, and forward and backward movements.

Exemplary embodiments of the present general inventive concept may be also achieved by providing a method of setting a mode including determining a movement of a terminal which is connected to an external device which is movable by a user's manipulation and is operable in a plurality of modes, determining a mode of the external device based on the movement of the terminal, and controlling the external device to be operated in the determined mode

Exemplary embodiments of the present general inventive concept may be also achieved by providing an electronic device including a plug unit which is connected to a communication device, and a body which is moved by a user's manipulation, which is attached to the plug unit, and which transmits information regarding a movement to the communication device. The electronic device may be operated in the mode determined by the communication device based on the information regarding the movement.

The movement of the body may include one of rotational, horizontal, vertical, and forward and backward movements.

Exemplary embodiments of the present general inventive concept may be also achieved by providing a method of setting a mode including transmitting to a communication device information regarding a movement of a body which is moved while attached to a plug connected to the communication device, and operating in a mode determined by the communication device based on the information regarding the movement.

Exemplary embodiments of the present general inventive concept may be also achieved by providing a method of selecting a mode of an external device when the external device is connected to a connector of a communication device, the method including determining a position of the connector, and executing a mode of the external device according to the determined position of the connector.

The position can include one of a rotational position, a horizontal position, a vertical position, and a position in a forward-and-backward direction. The mode of the external device can include a charging mode, an interactive communication mode, a one-way communication mode, a master mode, a slave mode, a two-way data transfer mode, executing a program stored on the external device, a read-only mode, and a mode permitting data to be stored on the external device.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a view illustrating a state before a conventional external device is connected to a terminal of a communication device through a cable;

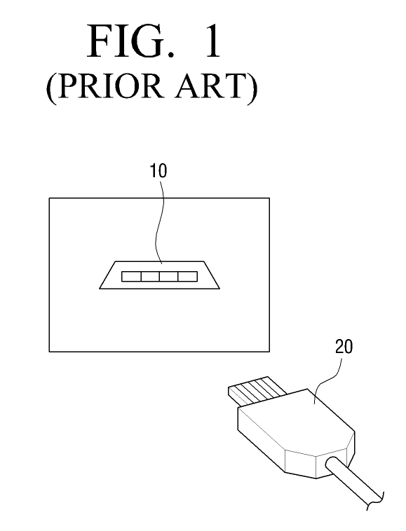

FIGS. 2A to 2C are views provided to illustrate a communication device which is capable of setting a mode by rotational movement according to an exemplary embodiment of the present general inventive concept;

FIG. 3 is a view provided to illustrate a communication device which is capable of setting a mode by horizontal movement according to another exemplary embodiment of the present general inventive concept;

FIG. 4 is a view provided to illustrate a communication device which is capable of setting a mode by vertical movement according to another exemplary embodiment of the present general inventive concept;

FIG. 5 is a view provided to illustrate a communication device which is capable of setting a mode by forward and backward movement according to another exemplary embodiment of the present general inventive concept;

FIG. 6 is a flowchart illustrating a method of setting a mode according to an exemplary embodiment of the present general inventive concept;

FIGS. 7A to 7C are views provided to illustrate a method of automatically setting a mode of an external device according to rotational movement of the body of the external device;

FIG. 8 is a flowchart illustrating a method of setting a mode according to another exemplary embodiment of the present general inventive concept; and

FIG. 9 is a block diagram illustrating a communication device according to an exemplary embodiment of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

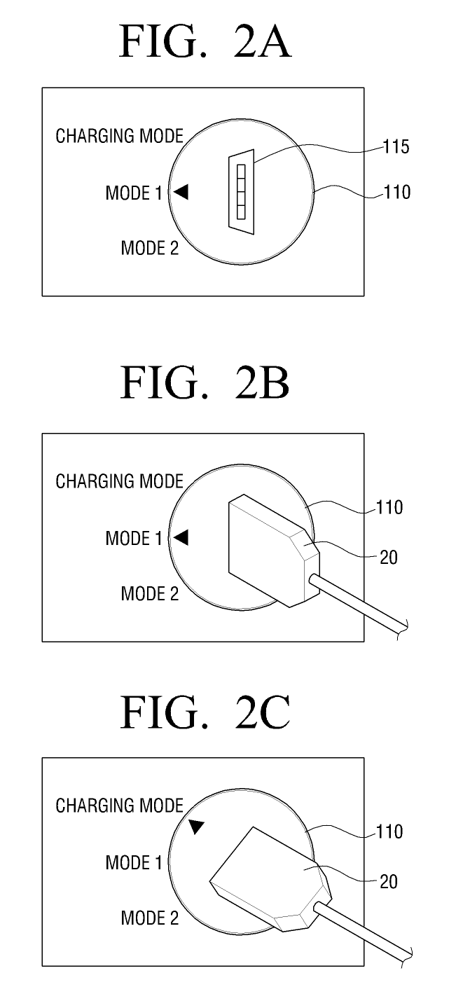

FIGS. 2A-2C illlustrate a part of a communication device to which an external device can be directly connected or connected through a cable.

The communication device may perform a communication function to perform data communication with the external device and a power supply function to supply power to the external device. The communication device can be connected to the external device according to an interface standard such as the USB interface standard or the IEEE 1394 standard so as to communicate with the external device according to the interface standard.

The communication device may communicate with the external device at a plurality of speeds. More specifically, the communication device may perform communication at a plurality of speeds for a plurality of communication interface standards or may perform communication at a plurality of speeds for a single communication interface standard.

If the external device (not illustrated) is connected to a terminal 115 provided on a connector 110 of the communication device through a cable 20 as illustrated in FIG. 2B and then if the connector 10 is rotated along with the plug of the cable 20 by the user as illustrated in FIG. 2C, the external device is connected to the communication device in a mode which corresponds to the position to which the connector 100 is rotated.

More specifically, the external device connected to the cable 20 can execute the mode which is indicated by an indicator, such as [symbol] displayed on the connector 110. As illustrated in FIG. 2C, as the external device connected to the cable 20 is connected to the communication device in the charging mode which is indicated by the indicator [symbol] the external device executes a charging mode.

If the plug of the cable 20 is not rotated along with the connector 110 in the state illustrated in FIG. 2B, the external device is connected to the communication device in the mode 1 which is indicated by the indicator [symbol] and thus executes the mode 1. Similarly, if the connector 10 is rotated along with the plug of the cable 20 by the user so that the indicator [symbol] indicates mode 2, the external device is connected to the communication device in the mode 2 and thus executes the mode 2. Various modes are further described below.

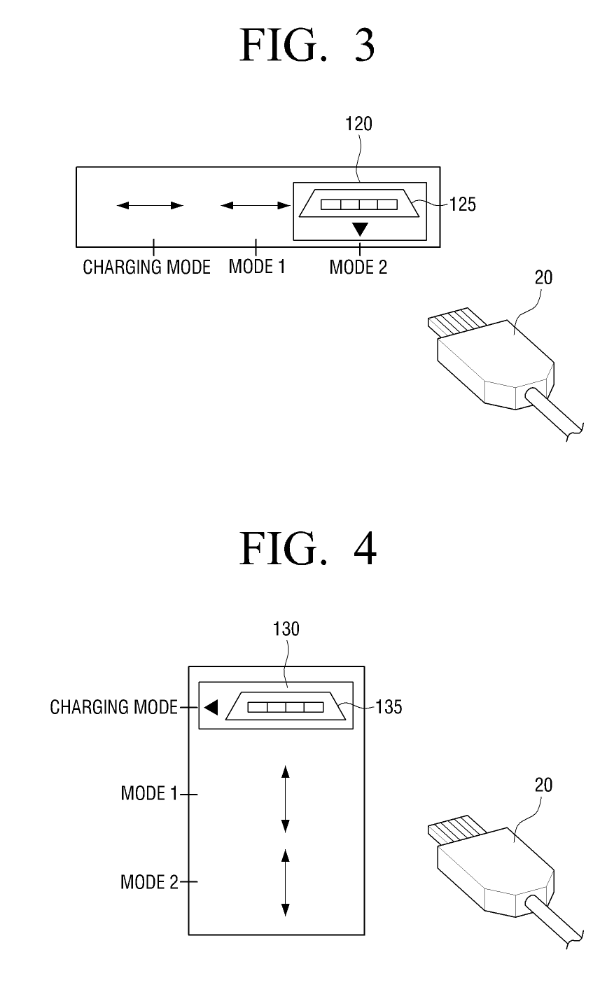

FIG. 3 illustrates another exemplary embodiment of the present general inventive concept. In this exemplary embodiment, if an external device (not illustrated) is connected to a terminal 125 provided on a connector 120 of a communication device through a cable 20 and then if the connector 120 is horizontally moved along with the plug of the cable 20 by the user, the external device is connected to the communication device in the mode which corresponds to the position to which the connector 120 is moved.

More specifically, the external device connected to the cable 20 can execute the mode which is indicated by an indicator, such as “▾”, displayed on the connector 120. If the connector 120 is not moved in the state illustrated in FIG. 3, the external device is connected to the communication device in the mode 2 which is indicated by the indicator “▾” and thus executes the mode 2. If the connector 120 is moved so that the indicator indicates, for example, the mode 1, or the charging mode, the external device can execute the indicated mode 1 or the charging mode.

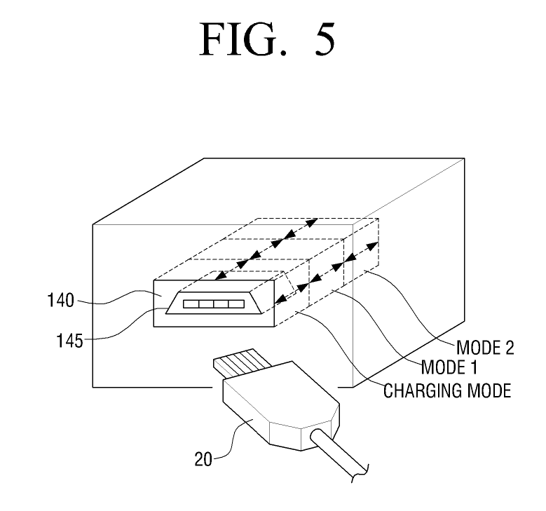

FIG. 4 illustrates another exemplary embodiment of the present general inventive concept. In this exemplary embodiment, if an external device (not illustrated) is connected to a terminal 135 provided on a connector 130 of a communication device through a cable 20 and then if the connector 130 is vertically moved along with the plug of the cable 20 by the user, the external device is connected to the communication device in the mode which corresponds to the position where the connector 130 is moved.

More specifically, the external device connected to the cable 20 can execute the mode which is indicated by an indicator, such as [symbol] displayed on the connector 130. If the connector 130 is not moved in the state illustrated in FIG. 4, the external device is connected to the communication device in the charging mode which is indicated by the indicator [symbol] and thus executes the charging mode. If the connector 130 is moved so that the indicator indicates, for example, the mode 1, or the charging mode, the external device can execute the indicated mode 1 or the charging mode.

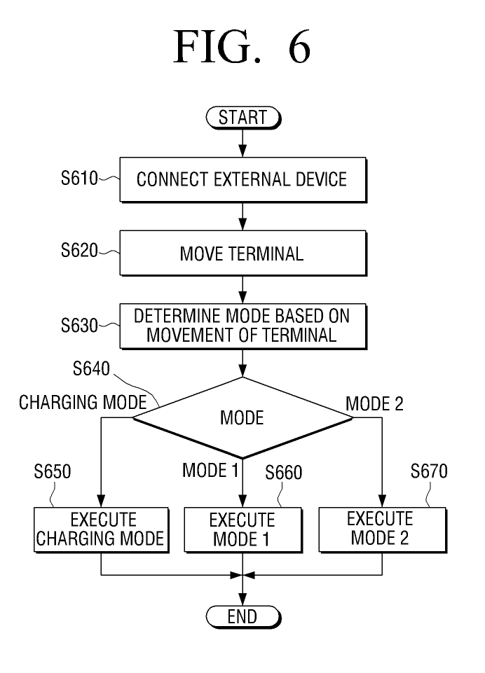

FIG. 5 illustrates still another exemplary embodiment of the present general inventive concept. In this embodiment, if an external device is connected to a terminal 145 provided on a connector 140 of a communication device through a cable 20 and then if the connector 140 is moved forward and backward along with the plug of the cable 20 by the user, the external device is connected to the communication device in the mode which corresponds to the position where the connector 140 is moved. As illustrated in FIG. 5, the direction of motion of the connector 140 can be substantially parallel to the direction in which the cable 20 is connected to the terminal 145

According to the aforementioned exemplary embodiments of the present general inventive concept, the external device can determine the mode according to rotational, horizontal, vertical, and forward and backward movements of the plug of the cable, the connector 110, 120, 130, 140 of the communication device, or the terminal 112, 125, 135, 145 provided on the connector 110, 120, 130, 140.

In the above-described exemplary embodiments, it is possible to change the mode simply by changing the position of the connector 110, 120, 130, 140 of the communication device, and the plug of the cable 20 need not be disconnected from the connector to change a mode.

Also, in the above-described exemplary embodiments, although the external device is described as connected to the connector 110, 120, 130, 140 of the communication device through a cable, this is merely an example. The present general inventive concept can also be applied to a case where the external device is directly connected to the connector 110, 120, 130, 140 without a cable. For example, the external device may have a USB or IEEE 1394 connector on a body of the external device, without a cable interposed between the external device and the connector 110, 120, 130, 140.

In this case, the external device can determine the mode according to rotational, horizontal, vertical, and forward and backward movements of the plug of the external device or the terminal provided on the connector 110, 120, 130, 140.

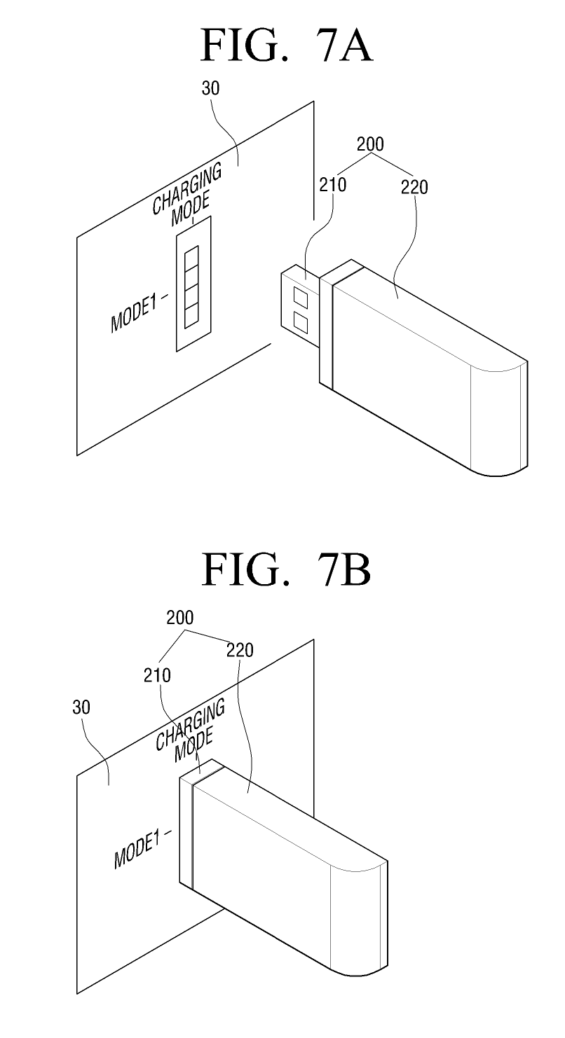

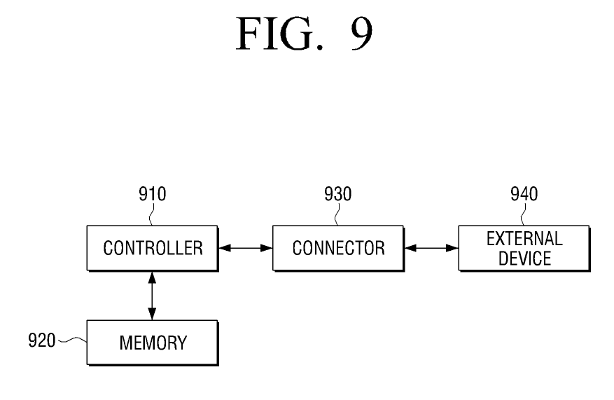

FIG. 6 is a flowchart illustrating a method of setting a mode, which can be performed according to the exemplary embodiments of the present general inventive concept described above. As illustrated in FIG. 6, if the external device is connected to the connector 110, 120, 130, 140 provided on the communication device in operation S610 and if the terminal provided on the connector 110, 120, 130, 140 is moved by the user in operation S620, a controller of the communication device can determine a corresponding mode based on the movement of the terminal in operation S630 and can control the external device to be operated in the determined mode in operations S640 to 670. For example, as illustrated in FIG. 9, the controller 910 of a communication device can determine a mode based on the movement of a terminal of the connector 930. Modes can be stored in a memory 920, or modes can be stored in the external device 940.

More specifically, if the charging mode is determined, the controller 910 can control the external device 940 to execute the charging mode in operation S650. If the mode 1 is determined, the controller 910 can control the external device 940 to execute the mode 1 in operation S660. If the mode 2 is determined, the controller 910 can control the external device 940 to execute the mode 2 in operation S670. Accordingly, the external device can be operated in the mode which is selected by the movement of the terminal of the connector 110, 120, 130, 140.

The types and number of modes provided in the above-described exemplary embodiments are not limited. For example, the plurality of modes may indicate a plurality of transmission speeds under the same interface standard or different versions of the same interface standard. Also, the plurality of modes may include at least two modes of charging mode, interactive communication mode, one-way communication mode, master mode, and slave mode. The one-way communication mode can include one-way data transfer from the communication device to the external device, and one-way data transfer from the external device to the communication device. A mode may also include two-way data transfer between the external device and the communication device, such as a data synchronization process. A mode can also include executing a program stored on the external device. In addition, a mode may also include setting the external device to “read only,” so that data stored on the external device can not be overwritten, or a mode can include “unlocking” the external device so that data may be written to and stored on the external device. Although exemplary embodiments of the present general inventive concept are described having a charging mode, a mode 1, and a mode 2, this is not a limitation, and any number of modes may be selected according to the present general inventive concept.

Each mode may be pre-defined in the manufacturing phase and can also be changeable by the user.

In the above-described exemplary embodiments, the mode of the external device can be determined by the rotational, horizontal, vertical, and forward and backward movements of the terminal provided on the connector 110, 120, 130, 140 of the communication device.

Hereinafter, another exemplary embodiment of the present general inventive concept is described in which a body of an external device is rotated about a plug and a mode of the external device is automatically set according to the rotational movement of the body of the external device.

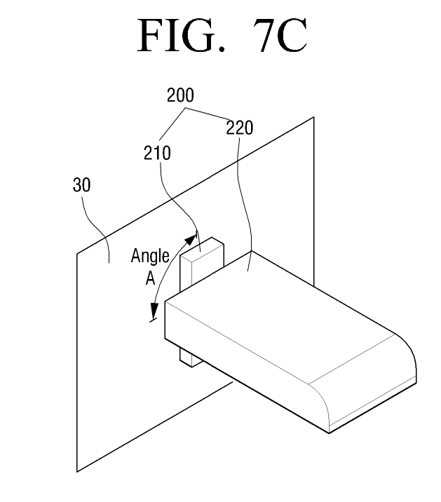

FIG. 7A illustrates an external device 200 including a plug unit 210 and a body 220, before being connected to a connector 30 provided on a communication device, and FIG. 7B illustrates the external device 200 after being connected to the connector 30.

FIG. 7B illustrates a state in which the plug unit 210 is connected to the connector 30. The body 220 of the external device 200 is not rotated relative to the plug unit 210. In the state illustrated in FIG. 7B, the external device 200 can be operated in a charging mode, which can be indicated on the connector 30.

As illustrated in FIG. 7C, the body 220 of the external device 200 can be rotated by a user, attached to the plug unit 210. As illustrated in FIG. 7C, if the body 220 of the external device 200 is rotated by an angle A, for example, 90°, the external device 200 can be operated in a mode 1, which can be indicated on the connector 30. Angle A is not limited to a rotation of 90°, and can be any number of different angles, which can correspond to different modes. For example, a rotation of 45°can indicate a mode 1, and a rotation of 90° can indicate a mode 2. Additional angles of rotation, such as 135°, 180°, and so forth, can also be used to indicate additional modes in accordance with the present general inventive concept. Additional modes can be indicated on the connector 30.

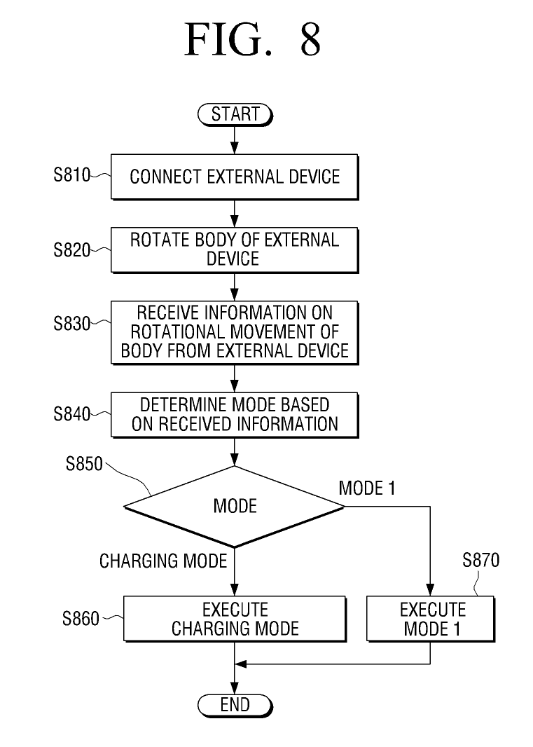

FIG. 8 is a flowchart illustrating a method of setting a mode, which can be performed according to the exemplary embodiments of the present general inventive concept. As illustrated in FIG. 8, if the external device 200 is connected to the connector 30 provided on the communication device in operation S810 and if the body 220 of the external device 200 is rotated by the user in operation S820, a controller (such as controller 910 illustrated in FIG. 9) of the communication device can receive information regarding the rotational movement of the body 220 of the external device 200 in operation S830 and can determine the mode of the external device 200 based on the received information.

In operations S850 to S870, the controller 910 can control a mode of the external device to be executed according to the mode determined in operation S840.

More specifically, if a charging mode is determined, the controller can control the external device to execute the charging mode in operation S860, and if a mode 1 is determined, the controller can control the external device to execute the mode 1 in operation S870.

In the above embodiment, the body 220 of the external device 200 can be rotated about the plug unit 210 and the mode of the external device 200 is automatically determined according to the rotational movement of the body 220 of the external device 200.

In addition, the rotation angle of the body 220 of the external device 200 may be set to, for example, 45°, 60°, 120° or 180° and setting a plurality of rotation angles is useful in the case where there are many modes of the external device.

Also, the rotational movement of the body 220 of the external device 200 may be substituted with other movements such as horizontal movement, vertical movement, and forward and backward movement.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in distributed fashion. The computer-readable transmission medium can transmit carrier waves and signals (e.g., wired or wireless data transmission through the Internet). Also, functional programs, codes, and code segments to accomplish the present general inventive concept can be easily construed by programmers skilled in the art to which the present general inventive concept pertains.

Although exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method of setting a mode of an external device which is operable in a plurality of modes, the method comprising:
connecting the external device to a communication device;
moving a terminal to which the external device is connected by a user; and
controlling the external device to be operated in at least one mode of the plurality of modes according to the movement of the terminal by the user.

2. The method as claimed in claim 1, wherein the communication device is a device which performs a communication function and a power supply function.

3. The method as claimed in claim 1, wherein the communication device communicates at a plurality of speeds.

4. The method as claimed in claim 1, wherein the communication device communicates according to a USB interface standard or an IEEE 1394 interface standard.

5. The method as claimed in claim 1, wherein the movement of the terminal by the user comprises at least one of rotational, vertical, horizontal, and forward and backward movements.

6. The method as claimed in claim 1, wherein the plurality of modes comprises a charging mode.

7. The method as claimed in claim 1, wherein the plurality of modes comprises a mode according to a plurality of transmission speeds according the same interface standard.

8. The method as claimed in claim 1, wherein the plurality of modes comprises a mode according to different versions of the same interface standard.

9. The method as claimed in claim 1, wherein the plurality of modes comprises at least two of a charging mode, an interactive communication mode, a one-way communication mode, a master mode, and a slave mode.

10. A communication device which is connectible with an external device which is operable in a plurality of modes, the communication device comprising:
a connector which is movably installed and is connected to the external device; and
a controller which determines a mode of the external device based on a movement of the connector,
wherein the plurality of modes comprises at least two modes of a communication mode, a charging mode, an interactive communication mode, a one-way communication mode, a master mode, a slave mode, a mode according to a plurality of transmission speeds according to the same interface standard, and a mode according to different versions of the same interface standard, and
wherein the movement of the connector comprises at least one of rotational, vertical, horizontal and forward and backward movements.

11. A communication device comprising:
a connector which is movable by a user's manipulation and is connected to an external device which is operable in a plurality of modes; and
a controller which determines a mode of the external device based on a movement of the connector and controls the external device to be operated in the determined mode.

12. The communication device as claimed in claim 11, wherein the user's manipulation is a manipulation to move the external device along with the connector or a manipulation to move a plug of a cable connected to the external device along with the connector.

13. The communication device as claimed in claim 11, wherein the movement of the connector by the user's manipulation comprises one of rotational, horizontal, vertical, and forward and backward movements.

14. A method of setting a mode comprising:
determining a movement of a terminal which is connected to an external device which is movable by a user's manipulation and is operable in a plurality of modes;
determining a mode of the external device based on the movement of the terminal; and
controlling the external device to be operated in the determined mode.

15. An electronic device comprising:
a plug unit which is connected to a communication device; and
a body which is moved by a user's manipulation, which is attached to the plug unit, and which transmits information regarding a movement to the communication device,
wherein the electronic device is operated in the mode determined by the communication device based on the information regarding the movement.

16. The electronic device as claimed in claim 15, wherein the movement of the body comprises one of rotational, horizontal, vertical, and forward and backward movements.

17. A method of setting a mode comprising:
transmitting to a communication device information regarding a movement of a body which is moved while attached to a plug connected to the communication device; and
operating in a mode determined by the communication device based on the information regarding the movement.

18. A method of selecting a mode of an external device when the external device is connected to a connector of a communication device, the method comprising:
determining a position of the connector; and
executing a mode of the external device according to the determined position of the connector.

19. The method of claim 18, wherein the position is one of a rotational position, a horizontal position, a vertical position, and a position in a forward-and-backward direction.

20. The method of claim 18, wherein the mode of the external device includes a charging mode, an interactive communication mode, a one-way communication mode, a master mode, a slave mode, a two-way data transfer mode, executing a program stored on the external device, a read-only mode, and a mode permitting data to be stored on the external device.
